(19) United States
(12) Patent Application Publication
(10) Pub. No.: US 2013/0061098 A1
(43) Pub. Date: Mar. 7, 2013

(54) FAILURE CHECK APPARATUS AND FAILURE CHECK METHOD

(71) Applicant: Eiichiro Shigehara, Nisshin-shi (JP)

(72) Inventor: Eiichiro Shigehara, Nisshin-shi (JP)

(73) Assignee: TOYOYA JIDOSHA KABUSHIKI KAISHA, Toyota-shi (JP)

(21) Appl. No.: 13/697,207

(22) PCT Filed: May 10, 2010
(86) PCT No.: PCT/JP2010/057910

§ 371 Date: Nov. 9, 2012

(51) Int. Cl. G06F 11/07; G06F 11/30

(52) U.S. Cl. 714/47.1; 714/E11.024; 714/E11.179

(57) ABSTRACT

The present invention is related to a failure check apparatus for performing a failure check of plural CPUs, wherein the failure check apparatus is configured to predict or detect a process load of the CPUs as a whole based on vehicle information related to processes of the CPUs, and change a way of performing a failure check according to a prediction or detection result of the process load. The CPUs may be CPUs in a multi-core processor. The failure check apparatus may perform the failure check if it is predicted or detected that the process load of the CPUs as a whole is lower than a predetermined reference.

### TECHNICAL FIELD

The present invention is related to a failure check apparatus and a failure check method of performing a failure check of plural CPUs.

### BACKGROUND ART

A multiprocessor device is known in which several job-based processor devices and a general control processor device for totally controlling the job-based processor devices are connected via a common bus, and a diagnostic test program for checking the failure of the job-based processor device is provided on a job-based processor device basis (see Patent Document 1). According to this configuration, the job-based processor device which detects a failure diagnoses the failure with the diagnostic test program installed therein, and thus does not need the assistance from the general control processor device in performing the diagnosis. Therefore, it is not required to occupy the common bus to interrupt other processes every time when the diagnosis is performed, and the process load is not applied to the general control processor device.

[Patent Document 1] Japanese Laid-open Patent Publication No. 7-325730

### DISCLOSURE OF INVENTION

### Problem to be Solved by Invention

Since CPUs of a vehicle-installed microcomputer (ECU) perform a failure check process in addition to a normal process (process for vehicle controls, for example), the normal process may be influenced by performing the failure check process.

Therefore, an object of the present invention is to provide a failure check apparatus and a failure check method which are capable of performing the failure check process such that the influence on the normal process of the CPUs is reduced at the minimum.

### Means to Solve the Problem

In order to achieve the aforementioned objects, according to the first aspect of the present invention a failure check apparatus for performing a failure check of plural CPUs is provided, wherein

the failure check apparatus is configured to predict or detect a process load of the CPUs as a whole based on vehicle information related to processes of the CPUs, and change a way of performing the failure check according to a prediction or detection result of the process load.

### Advantage of the Invention

According to the present invention, a failure check apparatus and a failure check method can be obtained which are capable of performing the failure check process such that the influence on the normal process of the CPUs is reduced at the minimum.

### BRIEF DESCRIPTION OF DRAWINGS

FIG. 1 is a diagram for illustrating a hardware configuration of a failure check apparatus according to an embodiment (first embodiment) of the present invention.

FIG. 2 is a diagram for illustrating a system layer in the case where SoC in which a multi-core CPU 12 is incorporated is used as a hardware resource.

FIG. 3 is a flowchart of an example of failure check test control in an OS.

FIG. 4 is a diagram for illustrating an example of a detailed configuration of the multi-core CPU 12 illustrated in FIG. 1.

FIG. 5 is a diagram for illustrating an overview of a connection status of multiplexers 201, 202 and 205 immediately before the failure check of a CPU core 101 is started.

FIG. 6 is a diagram for illustrating a status in which data for the failure check and an expected value are read.

FIG. 7 is a diagram for illustrating a status in which a test result is output from the CPU core 101.

FIG. 8 is a diagram for illustrating an overview of a connection status of multiplexers 201, 202 and 205 immediately after the failure check of the CPU core 101 is completed.

FIG. 9 is a flowchart of another example of failure check test control.

FIG. 10 is a diagram for illustrating a configuration in the case where the failure check test control is installed in an application layer.

FIG. 11 is a diagram for illustrating an overview of a triangle wave comparison PWM.

FIG. 12 is a diagram for schematically illustrating the change in the time period allocated to the CPU core due to the change in the carrier frequency (change in the rpm of an electric motor for driving a vehicle).

FIG. 13 is a diagram for schematically illustrating the change in the necessary search region in a surrounding monitoring system due to the change in the vehicle speed.

FIG. 14 is a diagram for illustrating a hardware configuration of a failure check apparatus according to another embodiment (second embodiment) of the present invention.

FIG. 15 is a diagram for illustrating an example of failure check test control for changing a part of a failure check of the CPU core to be performed according to a process load.

FIG. 16 is a diagram for illustrating an example of failure check test control for performing the task adjustment according to the process load to increase the executable opportunities of the failure check of the CPU core.

FIG. 17 is a diagram for illustrating an example of failure check test control for suspending the failure check if the process load becomes high during the test mode.

### DESCRIPTION OF REFERENCE SYMBOLS

1, 2 failure check apparatus
12 multi-core
13 data access controller
14 memory controller
15 recording medium
16 recording medium
18 timer
20 data bus
22 data bus
101, 102, 103, 104 CPU core
200 data controller
201 multiplexer
202 multiplexer
203 mode controller
204 CPU number register
205 multiplexer
210 failure check block
212, 214 storage part
216 comparing part

### BEST MODE FOR CARRYING OUT THE INVENTION

In the following, the best mode for carrying out the present invention will be described in detail by referring to the accompanying drawings.

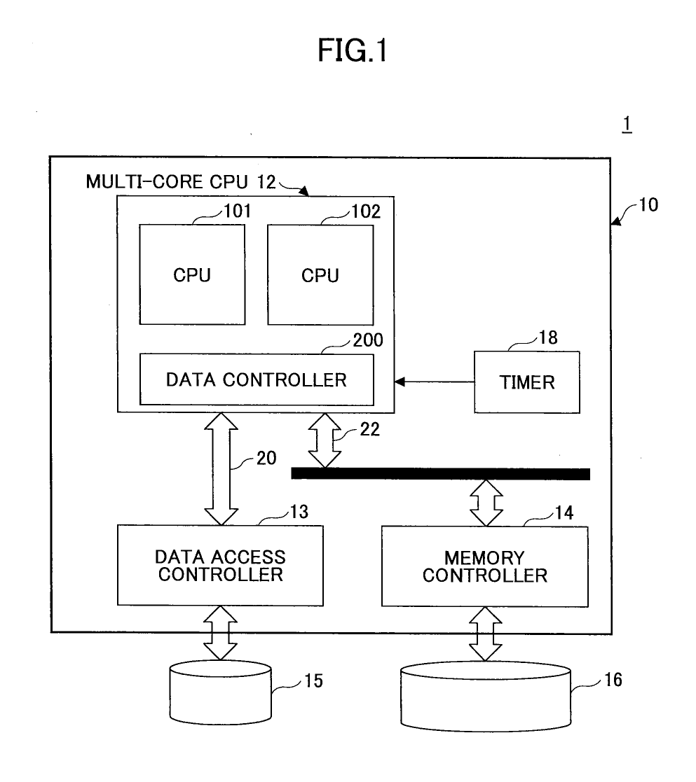

FIG. 1 is a diagram for illustrating a hardware configuration of a failure check apparatus according to an embodiment (first embodiment) of the present invention. The failure check apparatus 1 is embodied by a LSI (large-scale integration) 10. The LSI 10 includes a multi-core CPU 12, a data access controller 13, a memory controller 14, a timer 18, etc.

The multi-core CPU 12 includes plural CPU cores (two CPU cores 101 and 102, in this embodiment) and a data controller 200 for the data conjunction between the CPU cores 101 and 102.

The data access controller 13 controls the access to a recording medium 15 in which data necessary at the time of performing the failure check of the CPU cores 101 and 102 are stored. The recording medium 15 may be a memory, HDD, etc., for example. The data access controller 13 and the multi-core CPU 12 are connected by a data bus 20.

The memory controller 14 controls the access to a recording medium 16 in which programs and data necessary for normal operations are stored. The recording medium 16 may be a memory, HDD, etc., for example. The memory controller 14 and the multi-core CPU 12 are connected by a data bus 22.

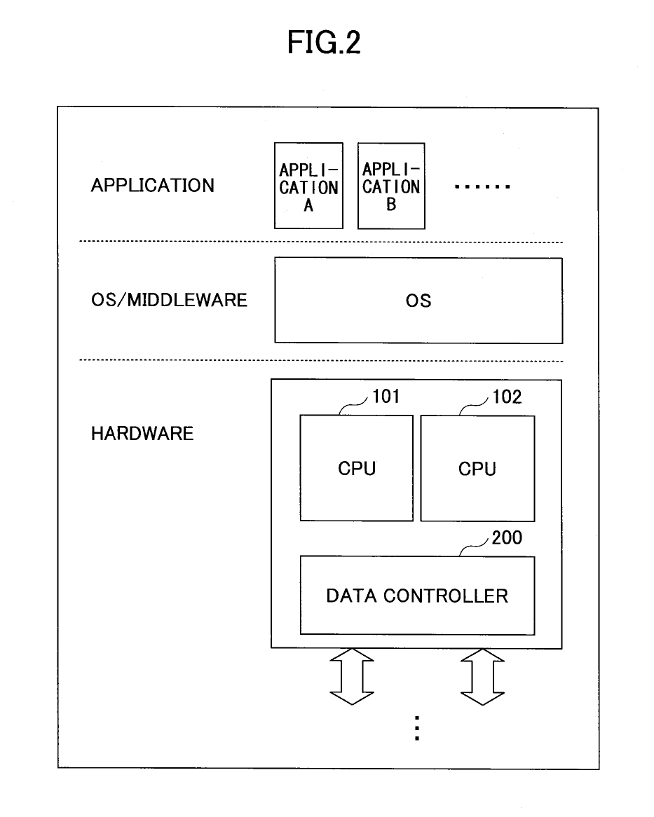

FIG. 2 is a diagram for illustrating a system layer in the case where SoC (System-on-a-chip) in which a multi-core CPU 12 is incorporated is used as a hardware resource. An OS estimates the future CPU load based on the application to be operated and performs the management of the operation status of the CPU cores 101 and 102 and the task allocation.

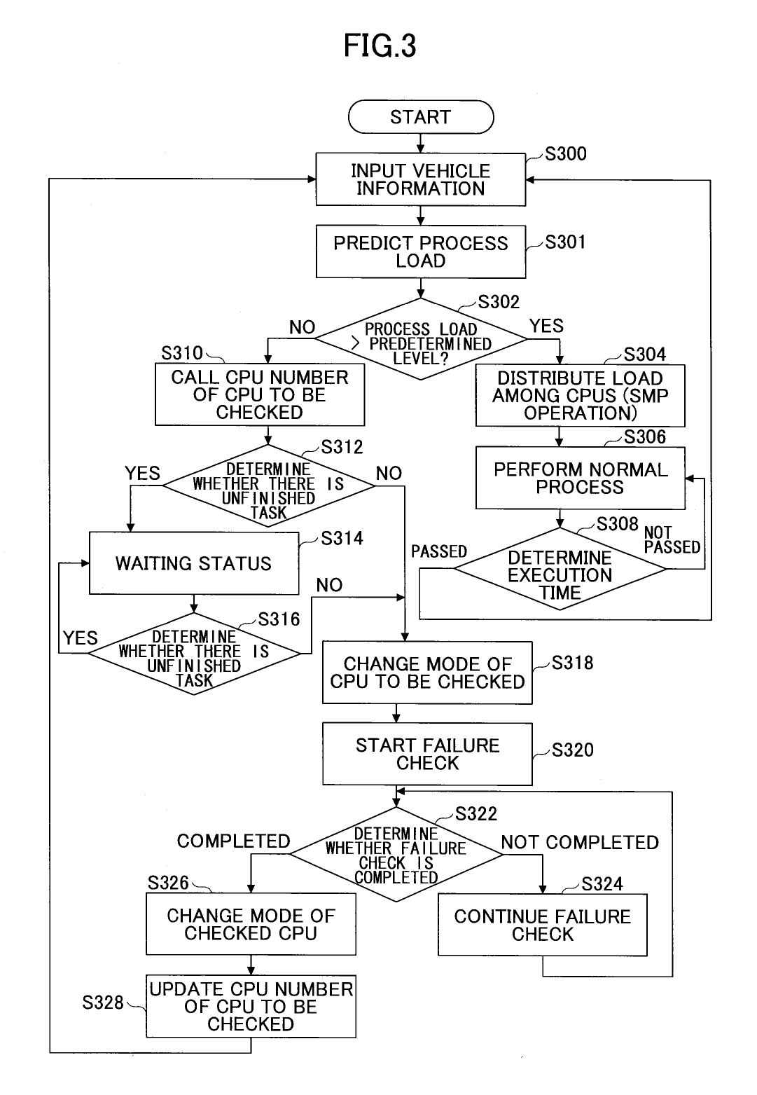

FIG. 3 is a flowchart of an example of failure check test control in an OS.

In step 300, vehicle information related to the process load of the CPU cores 101 and 102 is input. The vehicle information may be arbitrary as long as it can be used to predict (or detect) the process load of the CPU cores 101 and 102. The concrete examples of the vehicle information are described hereinafter.

In step 301, the process load of the CPU cores 101 and 102 (i.e., the process load of the multi-core CPU 12) is predicted based on the vehicle information input in step 300. For example, the process load of the CPU cores 101 and 102 within a predetermined time period T (referred to as a load prediction time period T, hereinafter) from the present time may be predicted. The load prediction time period T may correspond to a time (a maximum value of the time which may be taken for the processes from step 310 to step 328) required to perform the failure check described hereinafter. Further, the process load of the CPU cores 101 and 102 may be predicted as an average value or a maximum value of the process load of the CPU cores 101 and 102 within the load prediction time period T from the present time. It is noted that the process load of the CPU cores 101 and 102 is predicted assuming that the CPU cores 101 and 102 perform the normal operations from the present time, and is not the one which is predicted assuming that the CPU cores 101 and 102 perform the failure check described hereinafter.

In step 302, the process load predicted in step 301 is higher than a predetermined level. The predetermined level may correspond to the maximum level of the process load which can be handled by the single CPU core. In this case, the predetermined level may be individually adapted to the capability (performance) of the CPU cores 101 and 102. It is noted that in general the performance of the CPU core 101 is the same as the performance of the CPU core 102. If the process load predicted in step 301 is higher than a predetermined level, the process routine goes to step 304, determining that the process cannot be handled by the single CPU core. On the other hand, if the process load predicted in step 301 is not higher than the predetermined level, the process routine goes to step 310, determining that the process can be handled by the single CPU core.

In step 304, the CPU cores 101 and 102 are made to operate in the normal mode and the load is distributed between the CPU cores 101 and 102. In other words, the CPU cores 101 and 102 perform a SMP (Symmetric Multi-processing) operation.

In step 306, the CPU cores 101 and 102 perform the respective tasks which are scheduled by the OS.

In step 308, it is determined whether the execution time of the normal operations of the CPU cores 101 and 102 (the execution time measured from step 304) reaches the load prediction time period T. If the execution time of the normal operations of the CPU cores 101 and 102 does not reach the load prediction time period T, the process routine returns to step 306. On the other hand, if the execution time of the normal operations of the CPU cores 101 and 102 reaches the load prediction time period T, the process routine returns to step 300.

In step 310, the CPU number which indicates the CPU core to be subject to the failure check is called. The CPU number indicates any one of the CPU cores 101 and 102 which are called alternately in a predetermined order.

In step 312, it is determined whether the

CPU core (CPU core 101 or 102) to be checked has a task which has not been completed yet (i.e., a task under the processing). If there is a task which has not been completed yet, the process routine goes to step 314. On the other hand, if there is no task not completed yet, the process routine goes to step 318.

In step 314, the process routine becomes a waiting status for the task not completed yet.

In step 316, it is determined whether the CPU core (CPU core 101 or 102) to be checked has a task which has not been completed yet, as is the case with step 312 described above. If there is a task which has not been completed yet, the process routine returns to step 314. On the other hand, if there is no task not completed yet, the process routine goes to step 318.

In step 318, the mode of the CPU core (CPU core 101 or 102) to be checked is changed from the normal mode to a test mode. In this way, the operations of the CPU cores 101 and 102 are changed from the SMP to the AMP (Asymmetric Multiprocessing). Specifically, the CPU core 101 or 102 to be checked operates in the test mode and the other CPU core (the CPU core 101 or 102 which is not to be checked) performs the task scheduled by the OS.

In step 320, the test mode of the CPU core (CPU core 101 or 102) to be checked is started and a failure check process is started. Specifically, the reading of the failure check test data and the corresponding predicted value from the recording medium 15 via the data access controller 13 (see FIG. 1) is started. Then, the compared result between the predicted value and the test result is written in the recording medium.

During the test mode, the OS allocates all the tasks to the other CPU core (the CPU core 101 or 102 which is not to be checked). Even in such a case, as long as the prediction and the determination in steps 301 and 302 are appropriate, since all the tasks have the process load of the level which can be handled by the single CPU as described above, all the tasks can be handled by the other CPU core alone. Thus, the task allocated to the other CPU core at that time could include the task which would have been allocated to the CPU core to be checked if the CPU core performed the SMP operation.

The content of the failure check process in step 320 may be arbitrary as long as the failure check of its own can be performed appropriately. For example, the failure check process may include the operation (computation) test or the like of the ALU of the CPU core of its own. The preferred example of the failure check process is described hereinafter.

In step 322, it is determined whether the failure check process is completed. If it is determined that the failure check process is completed, the process routine goes to step 326. On the other hand, if it is determined that the failure check process is not completed, the process routine goes to step 324.

In step 324, the failure check process is continued. In order to continue the failure check process, the next failure check test data and the corresponding predicted value are read via the data access controller 13. Then, the compared result between the predicted value and the test result is written in the recording medium. The process of step 324 is continued until the failure check process is continued (until the test for all the failure check test data items is completed).

In step 326, the mode of the CPU core to be checked is changed from the test mode to the normal mode. In other words, the normal mode of the CPU core to be checked is restored.

In step 328, the data controller 200 in the multi-core CPU 12 updates the CPU number such that it indicates the next CPU core to be checked.

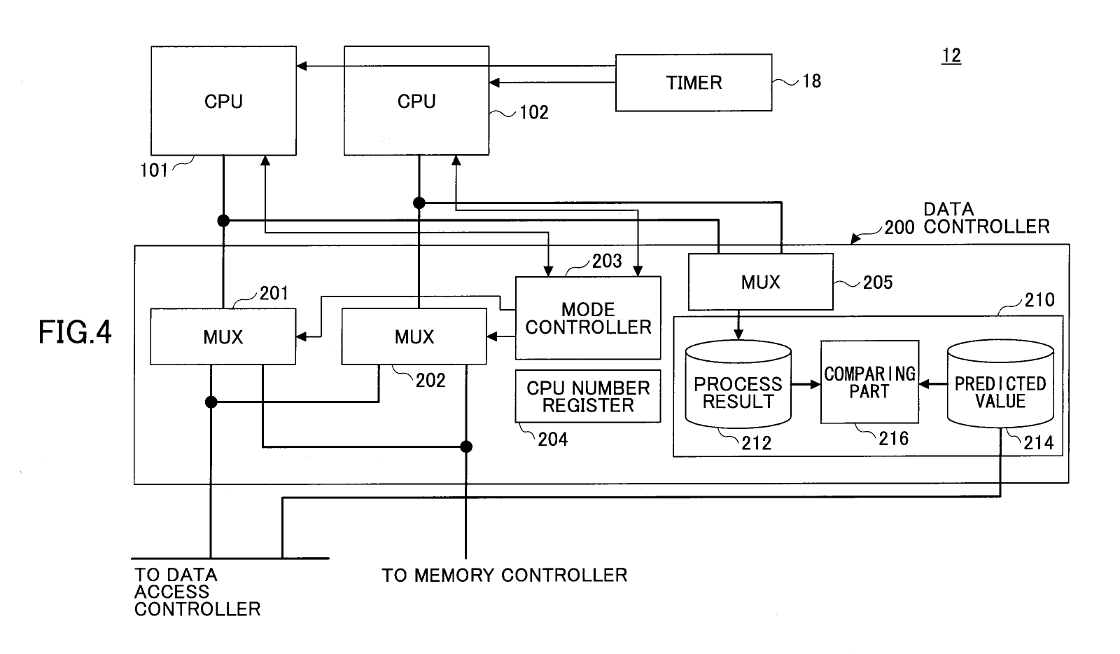

FIG. 4 is a diagram for illustrating an example of a detailed configuration of the multi-core CPU 12 illustrated in FIG. 1.

The data controller 200 of the multi-core CPU 12 includes multiplexers (MUX) 201, 202 and 205, a mode controller 203, a CPU number register 204, and a failure check block 210.

The multiplexer 201 selects one of the data access controller 13 (the data access controller 13 for accessing the recording medium 15 in which the data necessary for performing the failure check are stored) and the memory controller (the memory controller 14 for accessing the recording medium 16 in which the data necessary for normal operations are stored) with which the reading/writing of the input/output data of the CPU core 101 is performed.

The multiplexer 202 selects one of the data access controller 13 and the memory controller 14 with which the reading/writing of the input/output data of the CPU core 102 is performed, as is the case with the multiplexer 201.

The mode controller 203 selects the modes (the normal mode or the test mode for the failure check) of the CPU cores 101 and 102.

The CPU number register 204 stores the CPU number of the CPU core (the CPU core 101 or 102) to be checked next (see steps 310 and 328 in FIG. 3).

The multiplexer 205 selects the output data of the CPU core (the CPU core 101 or 102) to be checked.

The failure check block 210 has a function of comparing the output result (process result) of the CPU core (the CPU core 101 or 102) to be checked with the predicted value of the test result. The failure check block 210 includes a storage part 212 which stores the output result of the CPU core (the CPU core 101 or 102) to be checked; a storage part 214 which stores the predicted value of the test result; and a comparing part 216 which compares these.

Here, with reference to FIG. 3 and FIGS. 5 through 8, the explanation is given of the operation during the test mode, that is to say, until the test mode (failure check process) of the CPU core 101 is completed after the mode of the CPU core 101 is changed from the normal mode to the test mode.

It is noted that as a premise it is assumed that the CPU number register 204 of the data controller 200 has a value “0” stored therein. The value “0” corresponds to the CPU number of the CPU core 101 and the value “1” corresponds to the CPU number of the CPU core 102.

First, the vehicle information is input (see step 300 in FIG. 3). Next, the process load of the CPU cores 101 and 102 (i.e., the process load as a whole) is estimated (predicted) based on the input vehicle information (see step 301 in FIG. 3). If the estimated process load is at the level which cannot be handled by the single CPU core (see YES in step 302 in FIG. 3), the processes of steps 304 through 308 in FIG. 3 are performed and thus the test of the failure check is not performed.

At the next update timing of the vehicle information, the process load of the CPU cores 101 and 102 is estimated based on the input vehicle information (see step 301 in FIG. 3). If the estimated process load is at the level which can be handled by the single CPU core (see NO in step 302 in FIG. 3), the CPU number of the CPU core to be checked is read from the data controller 200 as the preparation for switching to the test mode for the failure check. At that time, since the value “0” is stored in the CPU number register 204, the CPU core 101 is the CPU core to be checked.

If the CPU core 101 is performing the normal process when the CPU core 101 is determined as the CPU core to be checked, it is not possible to immediately change the mode to start the failure check process (if the failure check process were started, the process result of the normal process would become abnormal). For this reason, the waiting state is formed until the CPU core 101 completes the process of the unfinished task (see steps 312 through 316 in FIG. 3).

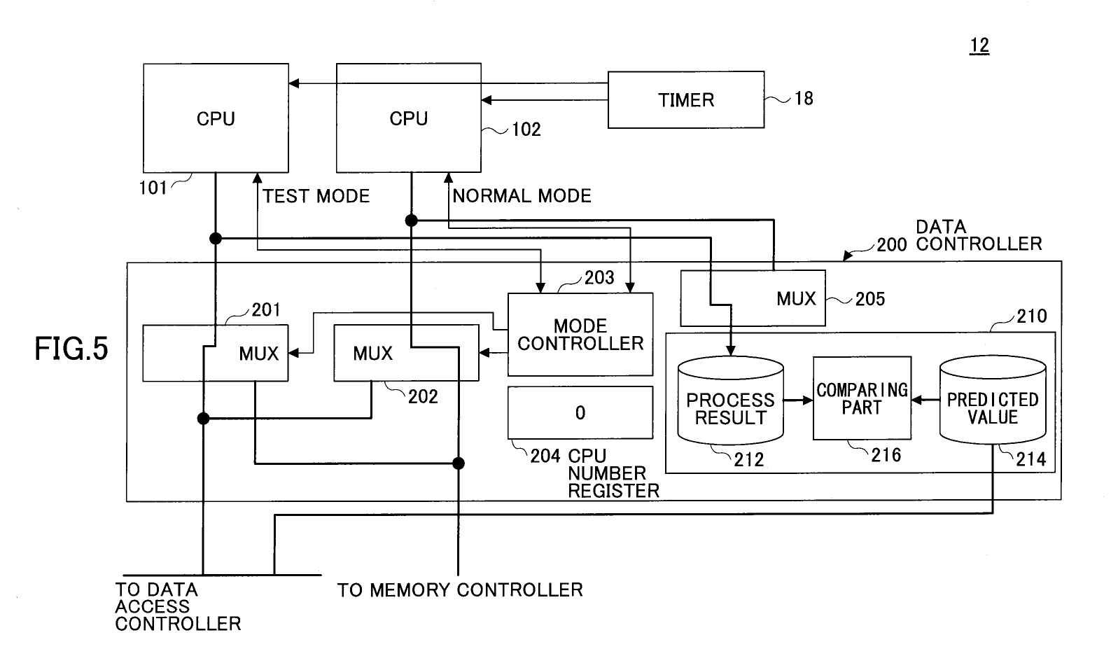

If there becomes no task being processed by the CPU core 101 (i.e., if the CPU core 101 has completed the process of the unfinished task), the mode of the CPU core 101 is changed by the mode controller 203 in the data controller 200 (see step 318 in FIG. 3). In other words, the mode of the CPU core 101 is changed from the normal mode to the test mode. At the same time, the mode controller 203 connects the multiplexers 201, 202 and 205 to the bus for the test. With respect to this state, the internal connection image of the multiplexers 201, 202 and 205 and the mode setting signals to the CPU cores 101 and 102 are illustrated in FIG. 5.

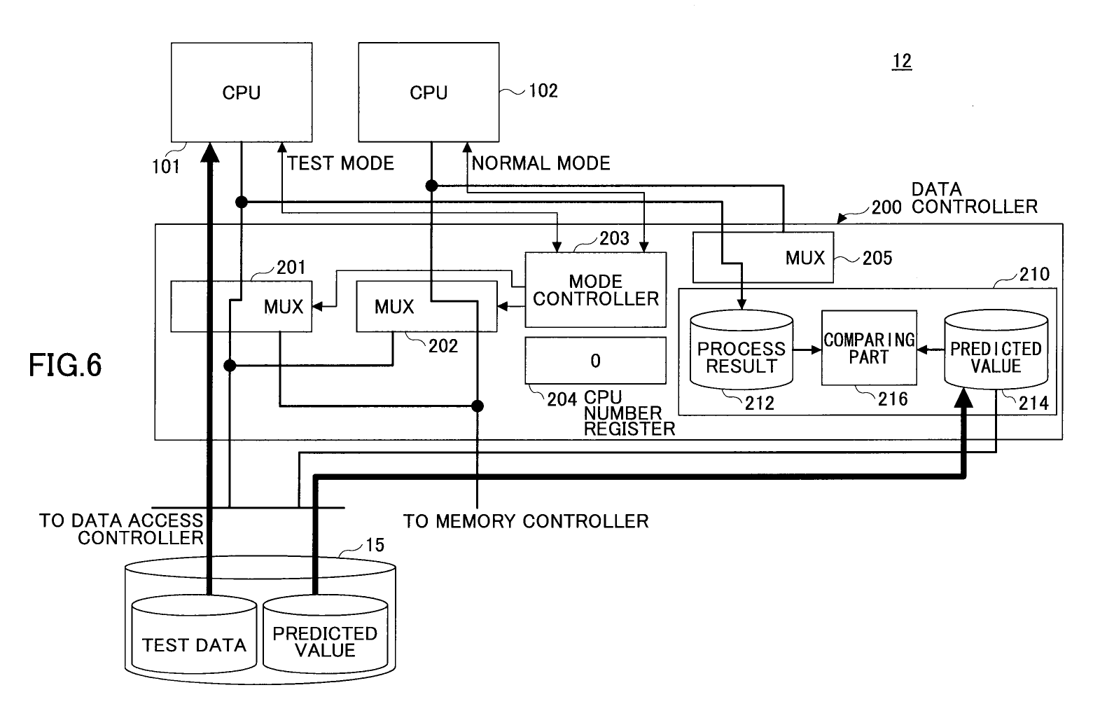

When the mode of the CPU core 101 is changed to the test mode and the connection to the bus for the test is implemented, the data for the failure check are input from the recording medium 15 for the test to the CPU core 101 and the corresponding predicted value is input from the recording medium 15 for the test to the storage part 214 of the failure check block 210. This state is illustrated in FIG. 6.

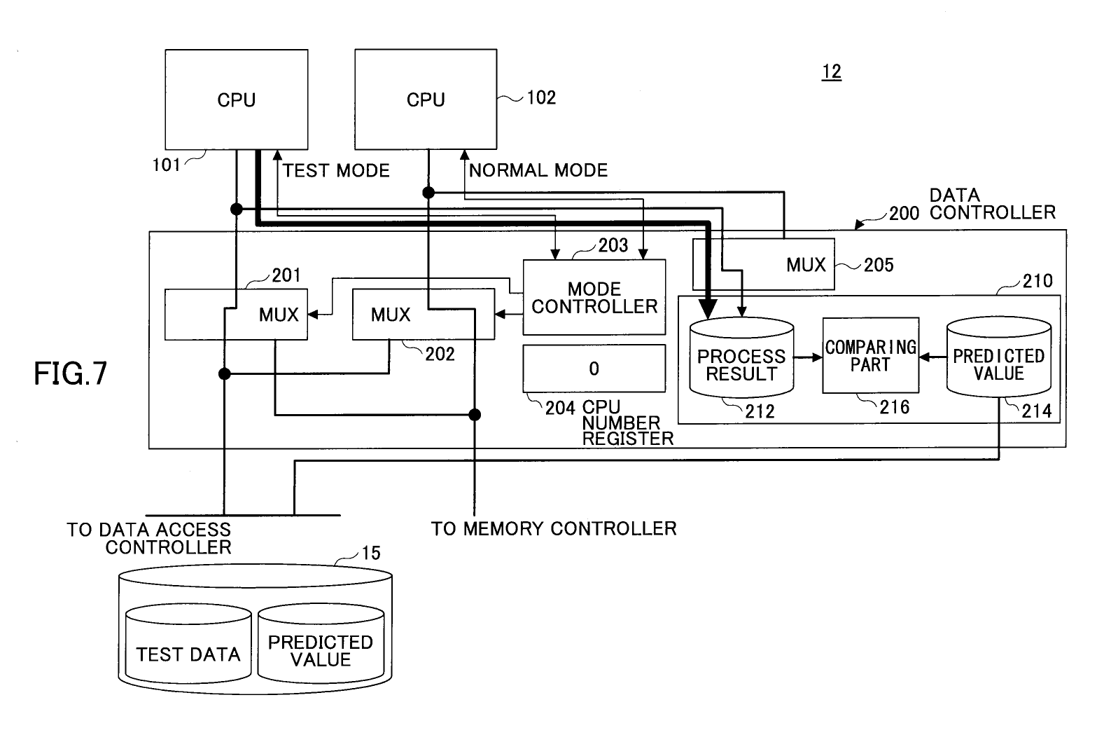

When the data for the failure check are input, the CPU core 101 processes the data and outputs the results one after another. The output results are stored in the storage part 212 of the failure check block 210 in the data controller 200. This state is illustrated in FIG. 7.

The data controller 200 compares the output results of the CPU core 101 with the predicted values in the storage part 214 one after another (see steps 320 through 324 in FIG. 3).

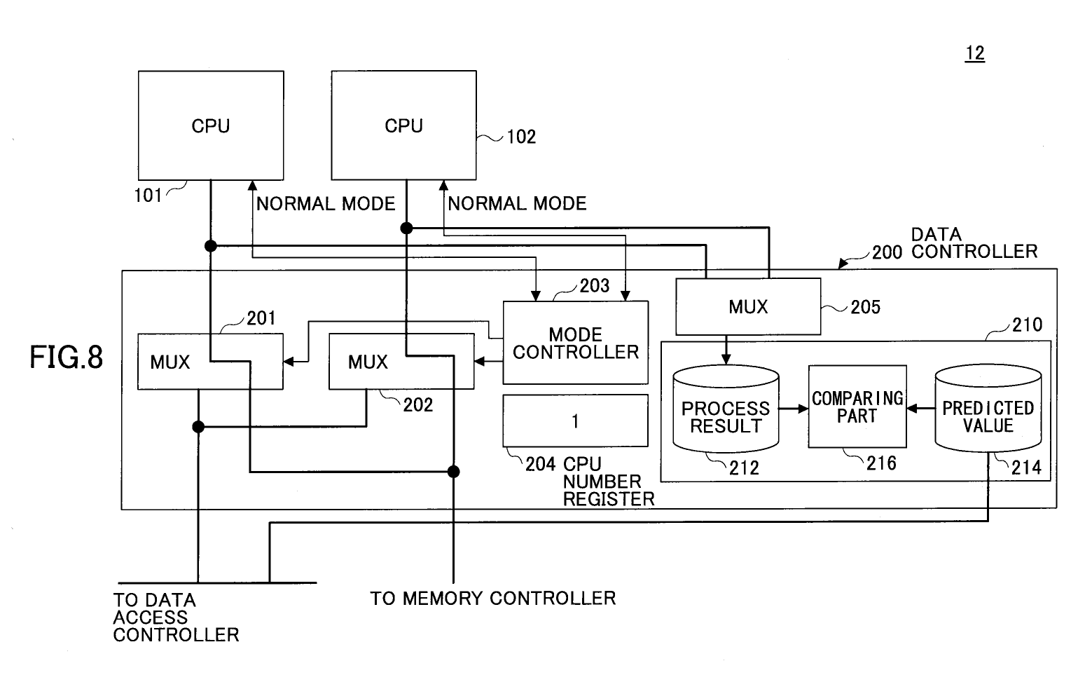

When the failure check process using all the failure check test data items is completed and the comparison between the respective output results and the corresponding predicted values is completed without any error, the mode of the CPU core 101 is changed from the test mode to the normal mode (see step 326 in FIG. 3). At the same time, the value of the CPU number register 204 is changed to “1” (see step 328 in FIG. 3). This state is illustrated in FIG. 8. It is noted that if the failure is detected as a result of the failure check result (i.e., if there is a mismatch between the respective output results and the corresponding predicted values), the output signal reporting the failure may be output. If this signal is output, such an audio and/or visual message that promotes a user (a driver) to exchange or examine the ECU due to the failure of the ECU may be output to the user (the driver).

It is noted that after that the process load of the CPU cores 101 and 102 is predicted and if the predicted process load is at the level which can be handled by the single CPU core within the time required for the failure check (i.e., the load prediction time period T), the failure check of the CPU core 102 is performed similarly.

According to the failure check apparatus 1 of this embodiment, the following effect among others can be obtained.

Since the failure check process is performed if the process load of the CPU cores 101 and 102 as a whole is low as described above, the failure check process of the CPU cores 101 and 102 can be performed without effecting the normal processes of the CPU cores 101 and 102. Specifically, by predicting the process load of the CPU cores 101 and 102 based on the vehicle information and performing the failure check while dynamically switching the operation mode of the multi-core CPU 12 from the SMP operation to the AMP operation, it becomes possible to implement the failure check of the CPU cores 101 and 102 without effecting the performance of the normal processes of the multi-core CPU 12. Further, since the failure check is performed for the respective CPU cores 101 and 102, it is possible to detect the failure of one of the CPU cores 101 and 102 and identify which of the CPU cores 101 and 102 fails under the situation where one of the CPU cores 101 and 102 fails.

It is noted that in the embodiment described above, the data for the failure check and the predicted values are read from the recording medium 15 to the data controller 200. However, in the case of the configuration in which the failure check of the CPU cores 101 and 102 is always performed using the same test pattern, the predicted values are fixed. Thus, in the case of such a configuration, the predicted values may be stored in advance in the storage area such as a ROM, a RAM or the like in the data controller 200. According to such a configuration, the data access via the data access controller 13 becomes unnecessary, and thus the risk of reduction of the bus capability in performing the failure check can be reduced.

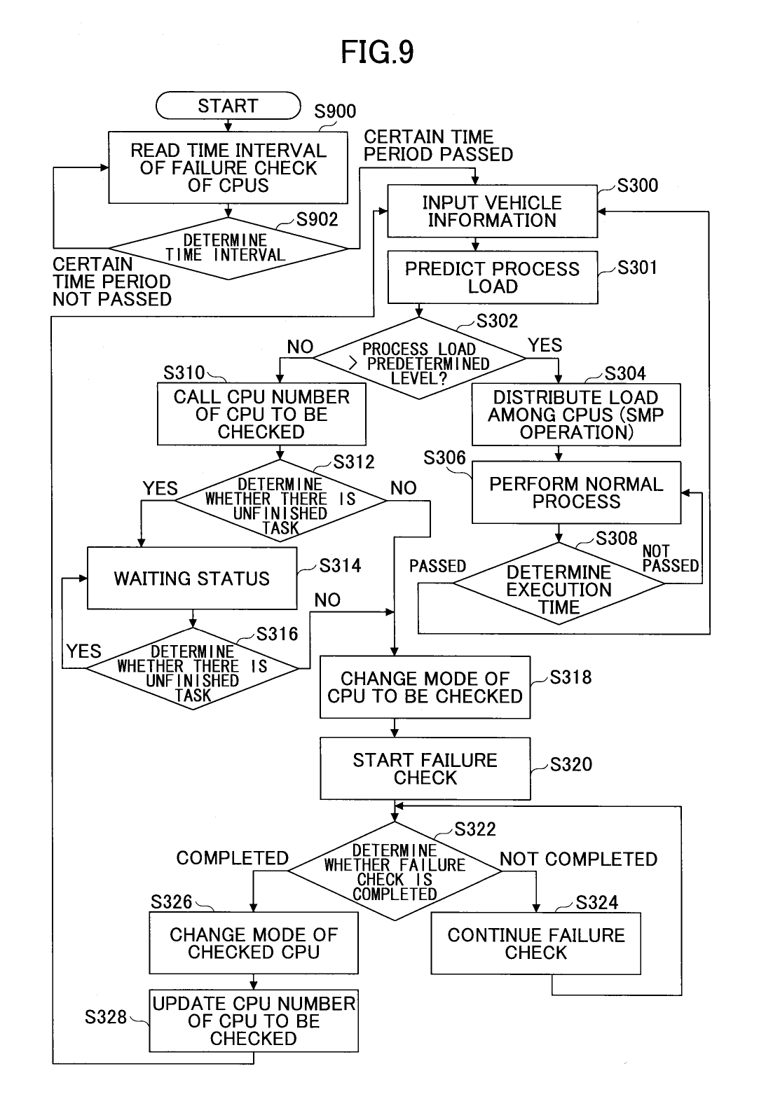

Further, according to the embodiment, the process routine illustrated in FIG. 3 is executed at a cycle corresponding to the update cycle of the vehicle information (1 s, for example); however, the execution cycle may be arbitrary, depending on the contents of the failure check, etc. For example, with respect to the check of the failure due to a secular variation, it is sufficient if the failure check is executed every day in the case of the minimum interval. Thus, the time when the previous failure check was executed may be stored, and the process in FIG. 3 may be executed only if the failure check is not performed for more than a certain time period. Specifically, as illustrated in FIG. 9, processes of step 900 and 902 may be added to the failure check test control illustrated in FIG. 3. In this case, the latest (previous) failure check timing of the CPU cores 101 and 102 is compared with the present time and the process routine in FIG. 3 (from step 300) is performed only if the failure check is not performed for more than a certain time period (a day, for example). It is noted that the failure check test control illustrated in FIG. 9 is suited for the case where the CPU cores 101 and 102 configure the ECU of the system which is not related to the vehicle driving performance (i.e., the system for enhancing the convenience or the comfort, such as a navigation system).

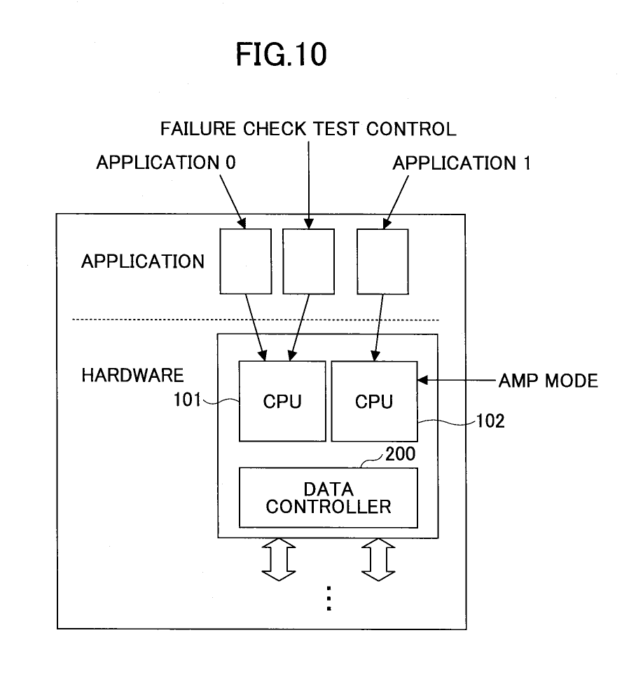

Further, in the embodiment described above the failure check test control (see FIG. 3) is implemented by the OS; however, the same effect can be obtained by using the application or middle layer. In this case, the CPU core for controlling the respective applications and the failure check test is determined in advance. For example, in the example illustrated in FIG. 10, the failure check test control is allocated to the CPU core 101. In this case, the CPU cores 101 and 102 operate in the AMP mode.

Next, concrete examples of a method of predicting the process load of the CPU cores 101 and 102 from the vehicle information are explained.

A first example is related to a method of predicting the process load of the CPU cores 101 and 102 using the carrier frequency of a PWM signal as the vehicle information. The PWM signal is used for the control of an electric motor for driving the vehicle. Here, the CPU cores 101 and 102 perform the control of the electric motor for driving the vehicle. In other words, the CPU cores 101 and 102 are in the ECU of a hybrid system.

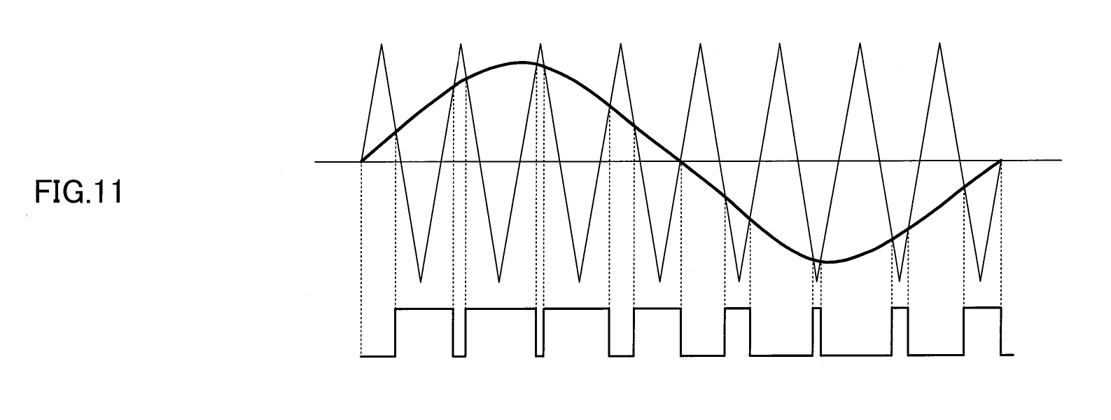

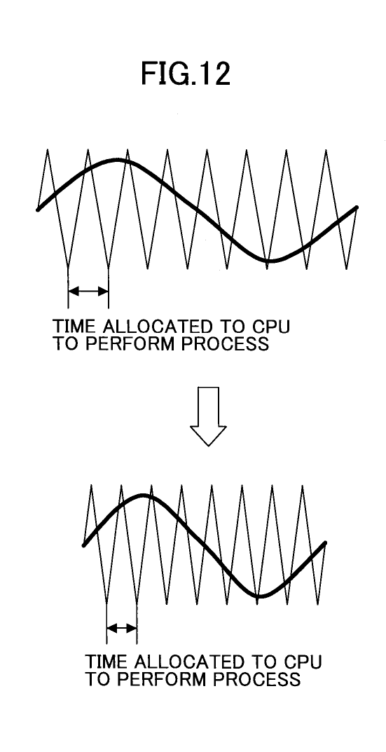

In the hybrid vehicle (and the electric vehicle), the vehicle traveling is controlled by controlling the electric motor for driving the vehicle. In general, a triangle wave comparison PWM such as illustrated in FIG. 11 is used for the control of the electric motor for driving the vehicle. A synchronized PWM control (carrier phase synchronization) is used so as to implement a smooth control of an inverter. According to the synchronized PWM control, the carrier frequency is varied with the rpm of the electric motor for driving the vehicle. In other words, according to the synchronized PWM control, the higher the rpm of the electric motor for driving the vehicle becomes, the higher the carrier frequency becomes. When the carrier frequency becomes high, the process capability demanded for the CPU cores 101 and 102 becomes high. Specifically, as illustrated in FIG. 12, when the carrier frequency becomes higher, the frequency of the sine wave becomes shorter, and the time allocated to the CPU cores 101 and 102 for performing the processes becomes shorter, and thus the process load of the CPU cores 101 and 102 becomes higher. Therefore, according to the system in which the control of the electric motor for driving the vehicle is performed with the synchronized PWM control, it is possible to predict the process load of the CPU cores 101 and 102 using the carrier frequency (and the counter for controlling the carrier frequency) as the vehicle information. For this reason, according to the first concrete example, a timer for the carrier frequency is used as the timer 18 (see FIG. 4). Further, according to the flowchart illustrated in FIG. 3, the carrier frequency control counter is input as the vehicle information (step 300), the process load of the CPU cores 101 and 102 is predicted based on the carrier frequency (see 301), and it is determined whether the predicted process load is higher than the predetermined level (step 302). It is noted that as the processes of steps 301 and 302 in FIG. 3, it may be determined whether the carrier frequency is higher than a predetermined threshold (predetermined frequency). In this case, based on a similar idea, the predetermined threshold may be adapted to the maximum level of the process load which can be handled by the single CPU core. For example, in the case where the operation frequency of the CPU cores 101 and 102 is 64 MHz, if the carrier frequency of the PWM signal is lower than 5 kH, the failure check may be performed, determining that the process load can be handled by the single CPU core. On the other hand, if the carrier frequency of the PWM signal is greater than or equal to 5 kH, the failure check may not be performed, determining that the process load cannot be handled by the single CPU core.

It is noted that in the first concrete embodiment, the carrier frequency of the PWM signal may be calculated or estimated based on other control information of the electric motor for driving the vehicle (the rpm, the torque, the rotation direction of electric motor for driving the vehicle, etc., for example).

A second concrete example is related to a method of predicting the process load of the CPU cores 101 and 102 using operation information of a user in the navigation (multimedia) system (or information on the control status of the system based on the operation of the user) as the vehicle information. Here, the CPU cores 101 and 102 perform the control of the navigation system. In other words, the CPU cores 101 and 102 are in the ECU of the navigation system.

In the navigation system the applications to be operated simultaneously can be recognized from the operations of the user (the screen operations on a touch panel, for example), and thus the process load of the CPU cores 101 and 102 can be predicted based on the operations of the user. For example, the applications which can be operated simultaneously by the screen operations of the user in the navigation system include the routing function of the navigation, the ripping of the CD, the reception and sound output of the DTV (Digital TV), etc. Here, the greater the number of the applications to be operated simultaneously becomes, the higher the process load of the CPU cores 101 and 102 becomes. Therefore, in the navigation system in which the applications can be operated simultaneously by the operations of the user, it is possible to predict the process load of the CPU cores 101 and 102 using the operation information of the user (and the number of the applications operated simultaneously by the operations) as the vehicle information. For this reason, according to the second concrete example, the operation information is input to the multi-core CPU 12. Further, according to the flowchart illustrated in FIG. 3, the operation information is input as the vehicle information (step 300), the number of the applications to be operated simultaneously is predicted as the process load of the CPU cores 101 and 102 based on the operation information (step 301), and it is determined whether the predicted process load is higher than the predetermined level (a predetermined number of the applications)(step 302). In this case, based on a similar idea, the predetermined number of the applications may be adapted to the maximum level of the process load (the maximum number of the applications) which can be handled by the single CPU core. For example, when the operation frequency of the CPU cores 101 and 102 is 400 MHz, the predetermined number of the applications may be two. In this case, if only the routing process, for example, is to be performed by the operation of the user, the failure check may be performed, determining that the process load can be handled by the single CPU core. On the other hand, if the routing process and the ripping process, for example, are to be performed simultaneously by the operations of the user, the failure check may not be performed, determining that the process load cannot be handled by the single CPU core.

A third concrete example is related to a method of predicting the process load of the CPU cores 101 and 102 using the information of the vehicle speed as the vehicle information. Here, the CPU cores 101 and 102 perform the control of a surrounding monitoring system using a vehicle-mounted surrounding monitoring camera. In other words, the CPU cores 101 and 102 are in the ECU of the surrounding monitoring system. Typically, in the surrounding monitoring system, a predetermined target object (the road markings such as the white line, the road traffic signs, the obstacles, for example) is detected by the image recognition from the image captured by the vehicle-mounted surrounding monitoring camera. It is noted that the image recognition result may be utilized in an alarm system for notifying the user of the existence of the obstacle or the like, for example, a vehicle control system for performing the vehicle control based on the positional relationship between the obstacle or the like and the host vehicle, etc.

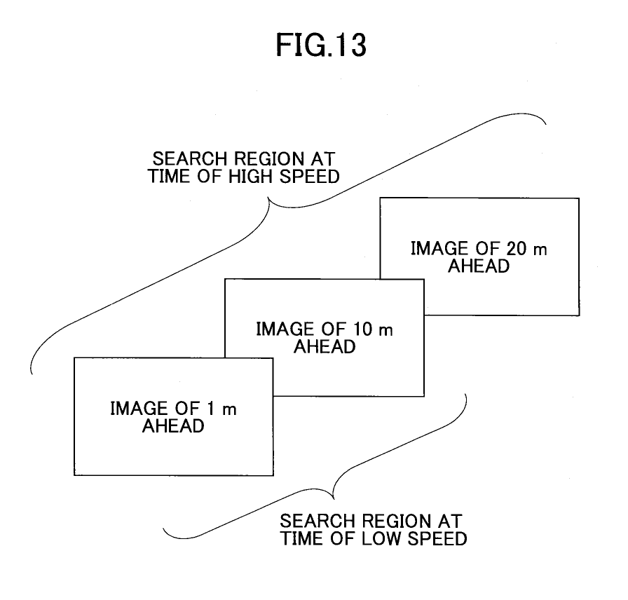

According to the surrounding monitoring system, the higher the vehicle speed becomes, the higher the process load of the CPU cores 101 and 102 becomes, because the search region for the target object such as the obstacle becomes larger. In other words, since the distance the vehicle travels in a predetermined time becomes greater as the vehicle speed becomes higher, the length of the region to be monitored becomes larger. For example, as conceptually illustrated in FIG. 13, the search region at the time of the low vehicle speed may be from the image of 1 m ahead to the image of 10 m ahead while the search region at the time of the high vehicle speed necessitates the image of 20 m ahead. Therefore, according to the surrounding monitoring system in which the image process region is varied with the vehicle speed, it is possible to predict the process load of the CPU cores 101 and 102 using the vehicle speed information as the vehicle information. For this reason, according to the third concrete example, the vehicle speed information is input to the multi-core CPU 12. The vehicle speed information may be obtained from a vehicle wheel speed sensor or may be information related to the vehicle speed, such as the rpm of the output shaft of a transmission. Further, according to the flowchart illustrated in FIG. 3, the vehicle speed information is input as the vehicle information (step 300), the search region for the target object is predicted as the process load of the CPU cores 101 and 102 based on the vehicle speed information (see 301), and it is determined whether the predicted process load is higher than the predetermined level (a search region)(step 302). In this case, based on a similar idea, the predetermined search region may be adapted to the maximum level of the process load (the maximum search region) which can be handled by the single CPU core. Alternatively, as the processes of steps 301 and 302 in FIG. 3, it may be determined whether the vehicle speed is higher than a predetermined threshold (predetermined vehicle speed). In this case, based on a similar idea, the predetermined vehicle speed may be adapted to the maximum level of the process load which can be handled by the single CPU core. For example, if the vehicle speed is within the low speed range which is lower than the predetermined vehicle speed, the failure check may be performed, having determined that the process load can be handled by the single CPU core. On the other hand, if the vehicle speed is within the middle or high speed range which is higher than or equal to the predetermined vehicle speed, the failure check may not be performed, having determined that the process load cannot be handled by the single CPU core.

A fourth concrete example is related to a method of predicting the process load of the CPU cores 101 and 102 using the information of the engine rpm as the vehicle information. Here, the CPU cores 101 and 102 perform the control of an engine control system. In other words, the CPU cores 101 and 102 configure an EFI-ECU. The engine control system performs various engine controls such as the fuel ejection, the ignition, etc.

In the engine control system, the higher the engine rpm becomes, the higher the process load of the CPU cores 101 and 102 becomes. Therefore, in the engine control system, it is possible to predict the process load of the CPU cores 101 and 102 using the engine rpm as the vehicle information. For this reason, according to the fourth concrete example, the engine rpm is input to the multi-core CPU 12. Further, according to the flowchart illustrated in FIG. 3, the engine rpm is input as the vehicle information (step 300), the process load of the CPU cores 101 and 102 is predicted based on the engine rpm (see 301), and it is determined whether the predicted process load is higher than the predetermined level (step 302). It is noted that as the processes of steps 301 and 302 in FIG. 3, it may be determined whether the engine rpm is higher than a predetermined threshold (predetermined engine rpm). For example, if the engine rpm is lower than the predetermined engine rpm, the failure check may be performed, having determined that the process load can be handled by the single CPU core. On the other hand, if the engine rpm is higher than or equal to the predetermined engine rpm, the failure check may not be performed, having determined that the process load cannot be handled by the single CPU core. In this case, based on a similar idea, the predetermined threshold (predetermined engine rpm) may be adapted based on the maximum level of the process load which can be handled by the single CPU core.

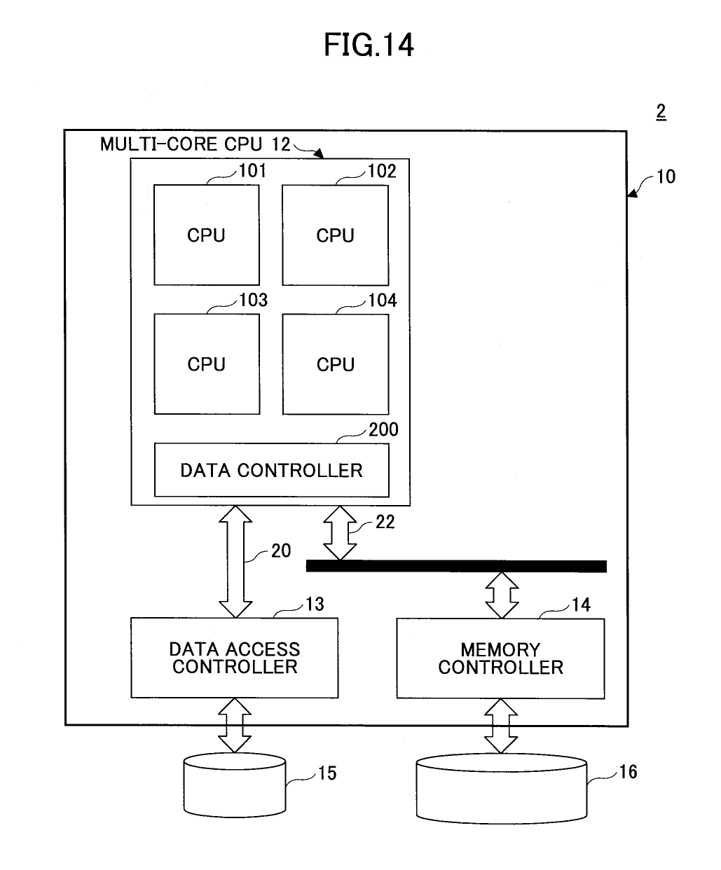

FIG. 14 is a diagram for illustrating a hardware configuration of a failure check apparatus 2 according to another embodiment (second embodiment) of the present invention.

The failure check apparatus 2 according to the present embodiment differs from the failure check apparatus 1 according to the embodiment described above mainly in the number of the CPU cores. Specifically, the failure check apparatus 2 according to the present embodiment has four CPU cores 101, 102, 103 and 104. In this way, the number of the CPU cores in the multi-core CPU 12 may be arbitrary as long as it is greater than or equal to two.

In the embodiment, the failure check test control may be performed as is illustrated in the flowchart in FIG. 3. In this case, with respect to the determination in step 302, the predetermined level may correspond to the maximum level which can be handled by three CPU cores. In other words, the predetermined level may correspond to the maximum level of the process load at which one CPU core can perform the failure check and other three CPU cores can perform the normal processes. In this case, similarly, the predetermined level may be individually adapted to the capability (performance) of the CPU cores 101, 102, 103 and 104. It is noted that in general the capabilities of the CPU cores 101, 102, 103 and 104 are the same. With respect to the determination of step 302, if the predicted process load is higher than the predetermined level, the process routine goes to step 304 where the CPU cores 101, 102, 103 and 104 perform the SMP operations. On the other hand, if the predicted process load is lower than the predetermined level, the process routine goes to step 310 where the CPU number of the CPU core to be checked is called. In the embodiment, the CPU number in the CPU number register 204 may be updated periodically in order of “0”, “1”, “2” and “3”, for example. The CPU numbers “0”, “1”, “2” and “3” correspond to the CPU cores 101, 102, 103 and 104, respectively. It is noted that the order of the update of the CPU number is arbitrary. For example, the CPU number may be updated periodically in order of “1”, “0”, “2” and “3”, for example.

Further, also in the present embodiment, the data controller 200 may have the same configuration as illustrated in FIG. 4. However, as are the case with the CPU cores 101 and 102 for which the multiplexers 201 and 202 are provided, respective multiplexers are provided for the CPU cores 103 and 104. Further, the CPU number register 204 is a 2-bit register to accommodate the four numbers of the CPU cores 101, 102, 103 and 104. Further, the multiplexer 205 is arranged such that it receives not only the input from the CPU cores 101 and 102 but also the input from the CPU cores 103 and 104.

It is noted that, according to the second embodiment, the CPU cores 101, 102, 103 and 104 are configured to perform the failure check one by one; however, the CPU cores 101, 102, 103 and 104 are configured such that one, two or three of the CPU cores 101, 102, 103 and 104 selectively perform the failure check in parallel. For example, if the predicted process load is at the level which can be handled by the single CPU core, the remaining three CPU cores may perform the failure check in parallel, if the predicted process load is at the level which cannot be handled by the single CPU core but can be handled by two CPU cores, the remaining two CPU cores may perform the failure check in parallel, and if the predicted process load is at the level which cannot be handled by the two CPU core but can be handled by three CPU cores, the remaining one CPU core may perform the failure check. In this case, three failure check blocks 210 (see FIG. 4) may be prepared.

The present invention is disclosed with reference to the preferred embodiments. However, it should be understood that the present invention is not limited to the above-described embodiments, and variations and modifications may be made without departing from the scope of the present invention.

For example, according to the embodiments described above, the process load of the CPU cores is predicted from the vehicle information and it is determined whether the failure check is to be performed based on the prediction result; however, the process load of the CPU cores may be detected from the vehicle information and it may be determined whether the failure check is to be performed based on the detection result. For example, if the time taken to perform the failure check process (the possibly maximum value of the time required for steps 310 through step 328 in FIG. 3) is substantially shorter than the time in which the process load of the CPU cores changes significantly, it may be determined whether the failure check is to be performed based on the process load of the CPU cores detected in real time. It is noted that in order to detect the process load of the multi-core CPU 12, the number of the functions called in the multi-core CPU 12 within a predetermined time period before the present time, etc., may be used as the vehicle information, in addition to the information described above such as the carrier frequency (the current value) of the PWM signal, etc.

Further, in the embodiments described above, whether the failure check of the particular one, two or more than two CPU cores are to be performed is determined according to whether the predicted process load of the multi-core CPU 12 is greater than the predetermined level; however, the way of performing the failure check may be changed more variously according to the predicted process load of the multi-core CPU 12.

For example, an execution part of the failure check with respect to the particular single CPU core may be changed according to the predicted process load of the multi-core CPU 12. More specifically, if the failure check is performed using plural failure check test data items, the number of the failure check test data items to be processed in performing the failure check with respect to the particular single CPU core may be adjusted according to the predicted process load of the multi-core CPU 12. In this case, at the next opportunity (or opportunities), the particular single CPU core processes the remaining failure check test data item(s) as the failure check of the particular single CPU core.

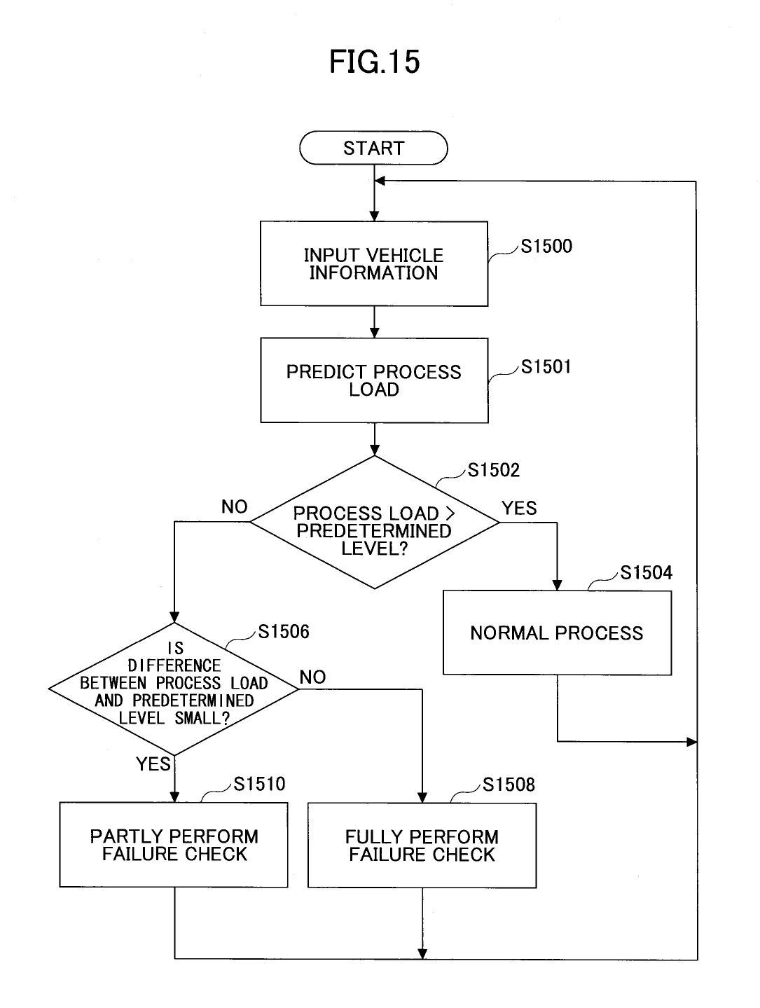

FIG. 15 is a diagram for illustrating an example of failure check test control for changing a part of a failure check of the CPU core to be performed according to a process load. According to the flowchart illustrated in FIG. 15, the vehicle information is input in step 1500 (as is the case with step 300), the process load of the CPU cores 101 and 102 is predicted in step 1501 (as is the case with step 301), and it is determined whether the predicted process load is higher than the predetermined level in step 1502 (as is the case with step 302). If the predicted process load is higher than the predetermined level, the normal process is performed in step 1504 (as is the case with steps 304, 306 and 308). On the other hand, if the predicted process load is not higher than the predetermined level, it is determined whether the difference between the predicted process load and the predetermined level is small in step 1506. In other words, it is determined whether the predicted process load is close to the predetermined level enough that the process load may exceed the predetermined level in a short time period (shorter than the load prediction time period T). If the difference between the predicted process load and the predetermined level is small, the process routine goes to step 1510, having determined that the process load afterward may exceed the predetermined level in a short time period which is shorter than the load prediction time period T. On the other hand, if the difference between the predicted process load and the predetermined level is not small, the process routine goes to step 1508. In step 1508, the process of the failure check is fully performed. The full failure check may be performed as described in steps 310 through 328 in FIG. 3. On the other hand, in step 1510, a part of the failure check is performed so that the failure check can be completed in the time period shorter than the load prediction time period T. The part of failure check may be performed as described in steps 310 through 328 in FIG. 3. However, in this case, in step 328, the CPU number is not updated until the remaining part of the failure check is performed. The remaining part of the failure check may be performed afterward at the opportunity (or opportunities) when the predicted process load becomes lower than the predetermined level.

It is noted that according to the failure check test control illustrated in FIG. 15, the predicted process load is evaluated substantially using two thresholds. In other words, if the predicted process load is higher than a first threshold (the predetermined level), the failure check is not performed, if the predicted process load is lower than the first threshold and higher than a second threshold (second predetermined level), a part of the failure check is performed, and if the predicted process load is lower than the second threshold, the entire failure check (with respect to the single CPU core) is performed. However, the process load may be divided into three or more thresholds. Alternatively, according to a variant of the failure check test control illustrated in FIG. 3, only the possible range of the failure check (a part of the failure check) may be performed even if the predicted process load is higher than the predetermined level.

Further, the task adjustment may be performed according to the predicted process load of the multi-core CPU 12 so that the failure check process can be performed. For example, according to the failure check test control illustrated in FIG. 3, the task adjustment between the CPU cores 101 and 102 is substantially implemented by switching to the AMP operation during the test mode. In addition to such a task adjustment, a task adjustment may be performed so that the failure check process can be performed if the predicted process load of the multi-core CPU 12 is higher than the predetermined level.

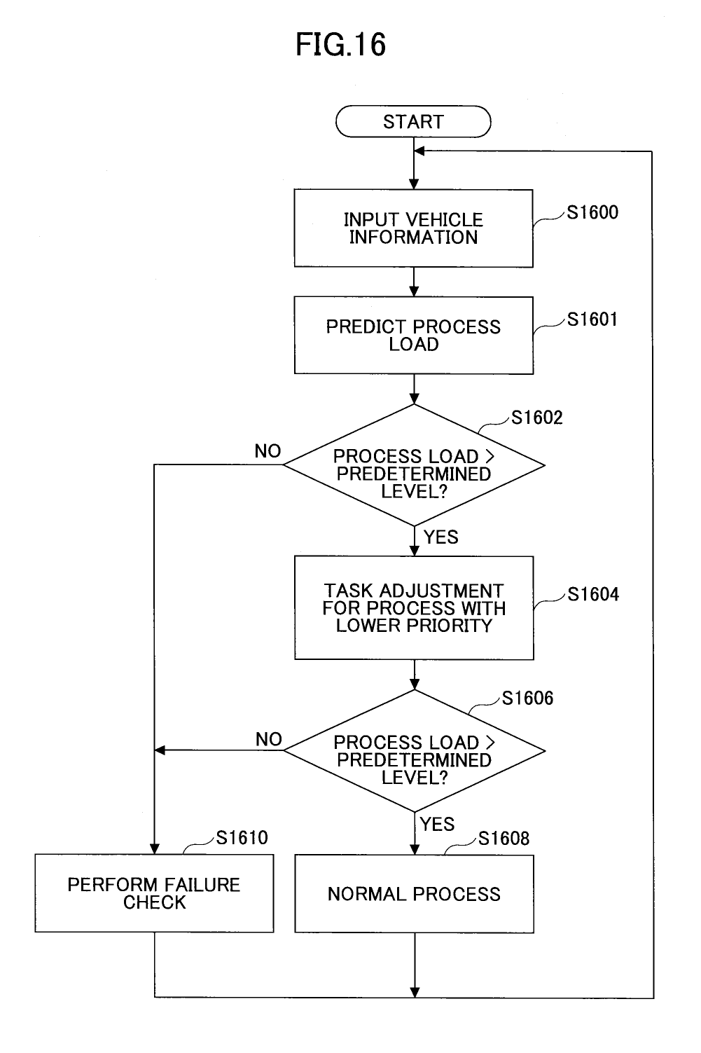

FIG. 16 is a diagram for illustrating an example of failure check test control for performing the task adjustment according to the process load to increase the executable opportunities of the failure check of the CPU cores.

According to the flowchart illustrated in FIG. 16, the vehicle information is input in step 1600 (as is the case with step 300), the process load of the CPU cores 101 and 102 is predicted in step 1601 (as is the case with step 301), and it is determined whether the predicted process load is higher than the predetermined level in step 1602 (as is the case with step 302). If the predicted process load is higher than the predetermined level, the task adjustment is performed in step 1604. The task adjustment may be performed such that the task with the lower priority is performed after the load prediction time period T, for example (i.e., the timing of performing task with the lower priority is delayed). In step 1606, the process load of the CPU cores 101 and 102 is predicted again considering the task adjustment in step 1604 (as is the case with step 301), and it is determined whether the predicted process load is higher than the predetermined level again in step 1606 (as is the case with step 302). If the predicted process load is still higher than the predetermined level, the normal process is performed in step 1608 (as is the case with steps 304, 306 and 308). However, in this case, the task adjustment performed in step 1604 may be canceled. On the other hand, if the predicted process load is lower than the predetermined level, the failure check is performed in step 1610 (as is the case with steps 310 through 328).

Further, there may be a case where the actual process load of the multi-core CPU 12 is different from the predicted process load of the multi-core CPU 12. Therefore, if the process load becomes high during the test mode so that the CPU core 101 or 102 which is not the CPU core to be checked cannot handle it, the test mode of the CPU core to be checked may be suspended.

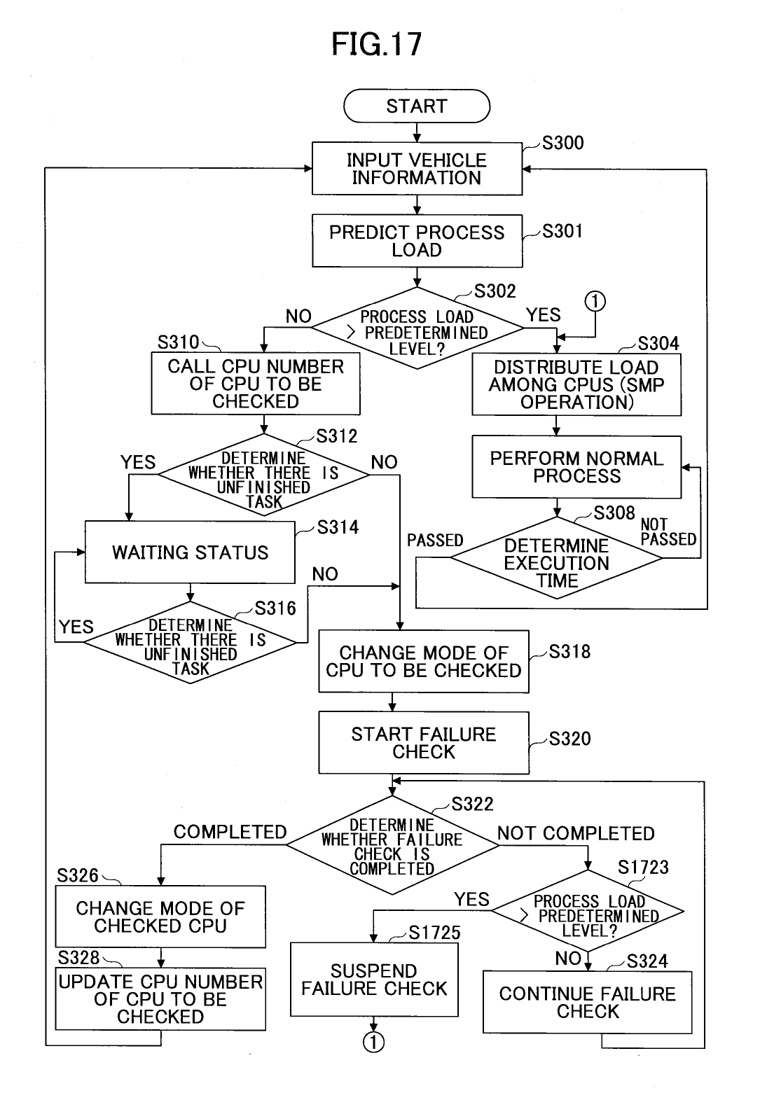

FIG. 17 is a diagram for illustrating an example of failure check test control for suspending the failure check if the process load becomes high during the test mode.

The flowchart illustrated in FIG. 17 differs from the failure check test control illustrated in FIG. 3 in that processes of step 1723 and step 1725 are added. In step 1723, during the test mode, the process load of the CPU cores 101 and 102 is predicted or detected again based on the newly input vehicle information, and if the predicted or detected process load is higher than the predetermined level, the process routine goes to step 1725 where the test mode of the CPU core to be checked is suspended. In this case, the mode of the CPU core to be checked is changed from the test mode to the normal mode, and thus goes to the process of step 304. It is noted that after that if the process load predicted in step 302 is lower than the predetermined level, the failure check of the CPU core to be checked is restarted from the process of step 302. The restart may be from the beginning of the failure check or from some midpoint.

Further, the embodiments described above are related to the multi-core CPU 12; however, they can be extendedly applied to a multi-processor system including plural microcomputers. In other words, the CPUs of the microcomputers may be handled as is the case with the CPU cores 101 and 102 (or the CPU cores 101, 102, 103 and 104) according to the embodiments described above. In this case, a configuration for coordinating the data between the microcomputers, which corresponds to the data controller 200 (see FIG. 4, etc.), is provided between the microcomputers. Further, the task adjustment necessary at the time of the failure check is performed between the microcomputers.

Finally, the following notations are disclosed in connection with the explanation described above.

### (Notation 1)

A failure check apparatus for performing a failure check of plural CPUs of a multi-core processor, wherein

the failure check apparatus is configured to

predict or detect a process load of the CPUs as a whole based on vehicle information related to processes of the CPUs; and

dynamically change an operation mode of the CPUs between a SMP and an AMP according to a prediction or detection result of the process load; and
a particular CPU of the CPUs performs the failure check of its own when the operation mode is changed to the AMP.

### (Notation 2)

The failure check apparatus of claim 1, wherein the failure check apparatus changes the operation mode from the SMP to AMP if the predicted or detected process load is lower than a predetermined reference.

### (Notation 3)

The failure check apparatus of Notation 1 or 2, wherein in the operation mode of the AMP the CPU(s) other than the particular CPU performs a normal process.

### (Notation 4)

The failure check apparatus of any one of Notations 1 through 3, wherein the operation mode of SMP is retained if the predicted or detected process load is higher than a predetermined reference.

### (Notation 5)

The failure check apparatus of any one of Notations 1 through 4, wherein the failure check apparatus changes, according to predicted or detected process load, a processing content (the number of failure check test data items to be processed or a range o be processed, for example) of the failure check to be performed by the particular CPU.

### (Notation 6)

The failure check apparatus of any one of Notations 1 through 5, wherein the particular CPU includes one or more CPUs.

### (Notation 7)

A failure check apparatus for performing a failure check of plural CPUs, wherein

the failure check apparatus is configured to predict or detect a process load of the CPUs as a whole based on vehicle information related to processes of the CPUs, and change a way of performing the failure check according to a prediction or detection result of the process load.

### (Notation 8)

The failure check apparatus of Notation 7, wherein the CPUs are CPUs in a multi-core processor.

(Notation 9) The failure check apparatus of Notation 7 or 8, wherein the failure check apparatus performs the failure check if it is predicted or detected that the process load of the CPUs as a whole is lower than a predetermined reference.

### (Notation 10)

The failure check apparatus of any one of Notations 7 through 8, wherein the failure check apparatus does not perform at least a part of the failure check (i.e., the failure check apparatus performs only a part of the failure check or does not perform the failure check at all) if it is predicted or detected that the process load of the CPUs as a whole is higher than a predetermined reference.

### (Notation 11)

The failure check apparatus of any one of Notations 1 through 10, wherein the failure check apparatus stops performing at least a part of the failure check if the process load of the CPUs as a whole becomes higher than a predetermined reference during the failure check.

(Notation 12) The failure check apparatus of any one of

Notations 1 through 11, wherein the CPUs perform the failure check of their own on a CPU basis.

### (Notation 13)

The failure check apparatus of any one of Notations 1 through 12, wherein the failure check apparatus performs adjustment of tasks between the CPUs when the failure check apparatus performs the failure check.

(Notation 14) The failure check apparatus of any one of

Notations 1 through 13, wherein the CPUs perform a control of a driving motor, and

the vehicle information is related to a rpm of the driving motor.

### (Notation 15)

The failure check apparatus of any one of Notations 1 through 14, wherein the CPUs perform a control of an engine, and

the vehicle information is related to a rpm of the engine.

### (Notation 16)

The failure check apparatus of any one of Notations 1 through 15, wherein the vehicle information is related to a vehicle speed.

### (Notation 17)

The failure check apparatus of any one of Notations 1 through 15, wherein the CPUs perform a control of a surrounding monitoring system, and

the vehicle information is related to a vehicle speed.

### (Notation 18)

The failure check apparatus of any one of Notations 1 through 17, wherein the CPUs perform a control of a navigation system, and

the vehicle information is related to an operation of a user for the navigation system.

(Notation 19) The failure check apparatus of any one of

Notations 7, 9 through 18, wherein the CPUs are CPUs which are included in plural microcomputers.

1. A failure check apparatus for performing a failure check of plural CPUs, wherein
the failure check apparatus is configured to predict or detect a process load of the CPUs as a whole based on vehicle information related to processes of the CPUs, and change a way of performing the failure check according to a prediction or detection result of the process load.

2. The failure check apparatus of claim 1, wherein the CPUs are CPUs in a multi-core processor.

3. The failure check apparatus of claim 1, wherein the failure check apparatus performs the failure check if it is predicted or detected that the process load of the CPUs as a whole is lower than a predetermined reference.

4. The failure check apparatus of claim 1, wherein the failure check apparatus does not perform at least a part of the failure check if it is predicted or detected that the process load of the CPUs as a whole is higher than a predetermined reference.

5. The failure check apparatus of claim 1, wherein the failure check apparatus stops performing at least a part of the failure check if the process load of the CPUs as a whole becomes higher than a predetermined reference during the failure check.

6. The failure check apparatus of claim 1, wherein the CPUs performs the failure check of their own on a CPU basis.

7. The failure check apparatus of claim 1, wherein the failure check apparatus performs adjustment of tasks between the CPUs when the failure check apparatus performs the failure check.

8. The failure check apparatus of claim 1, wherein the CPUs perform a control of a driving motor, and
the vehicle information is related to a rpm of the driving motor.

9. The failure check apparatus of claim 1, wherein the CPUs perform a control of an engine, and
the vehicle information is related to a rpm of the engine.

10. The failure check apparatus of claim 1, wherein the vehicle information is related to a vehicle speed.

11. A failure check method of performing a failure check of plural CPUs of a multi-core processor, comprising:
inputting vehicle information related to processes of the CPUs;
predicting or detecting a process load of the CPUs as a whole based on the vehicle information; and
changing a way of performing the failure check according to a prediction or detection result of the process load.
